(19) United States
(12) Patent Application Publication
(10) Pub. No.: US 2021/0341105 A1
(43) Pub. Date: Nov. 4, 2021

(54) Cryogenic fluid management

(71) Applicant: Teknologian tutkimuskeskus VTT Oy, Espoo (FI)

(72) Inventors: Antti Pohjoranta, Espoo (FI); Kaj Nikiforow, Espoo (FI)

(21) Appl. No.: 17/280,220

(22) PCT Filed: Sep. 18, 2019
(86) PCT No.: PCT/FI2019/050668

§ 371 Date: Mar. 26, 2021

(30) Foreign Application Priority Data
Sep. 26, 2018 (FI) 20185804

(51) Int. Cl. F17C 7/04

(52) U.S. Cl. CPC F17C 7/04; F17C 2223/0161; F17C 2270/0105; F17C 2221/033; F17C 2227/0334; F17C 2227/0114

(57) ABSTRACT

According to an example aspect of the present invention, there is provided a system comprising a cryogenic liquid storage tank, a first pressure tank and a second pressure tank, both connected via leads to the storage tank, at least one ejector, each of the at least one ejector being connected via leads to both pressure tanks, and a controller, the controller being configured to admit cryogenic fluid from the storage tank to the first pressure tank, to cause the cryogenic fluid to be heated to convert it into gas form, and to admit the fluid in gas form from the first pressure tank through a first ejector from among the at least one ejector, such that the fluid in gas form acts as a motive fluid to cause evacuation of the second pressure tank as it passes through the first ejector.

### FIELD

The present invention relates to conveying of cryogenic fluids.

### BACKGROUND

Liquefied gases may be used in various applications, such as, for example, as fuel in combustion engines or in fuel cells, following evaporation. Storing and pumping some liquefied gases, such as LNG, LH2 or LO2, is more challenging than storing and pumping normal liquids, which are liquid at room temperature and normal atmospheric pressure. Examples of liquefied gases, which require cryogenic storage include liquid hydrogen, LH2, and liquefied natural gas, LNG. Other gases may be stored in the liquid phase merely at pressure, without needing cryogenic temperature.

Liquefied gas storage tanks may be carefully insulated and/or refrigerated to maintain a cryogenic temperature, and solidly built to withstand pressure. Steel, for example, may be employed in building such containers.

Cryogenic pumps are used to transfer cryogenic fluids from a container toward a point of use. Pumping liquefied gases has been performed using submerged multiple-phase turbo pumps and gas-phase turbo pumps, for example. Submerged pumps are useful where heat leakage is not a major concern, while long shaft pumps separate the pump motor from a pump impeller, minimising heat transfer.

### SUMMARY OF THE INVENTION

According to some aspects, there is provided the subject-matter of the independent claims. Some embodiments are defined in the dependent claims.

According to a first aspect of the present invention, there is provided a system comprising a cryogenic liquid storage tank, a first pressure tank and a second pressure tank, both connected via leads to the storage tank, at least one ejector, each of the at least one ejector being connected via leads to both pressure tanks, and a controller, the controller being configured to admit cryogenic fluid from the storage tank to the first pressure tank, to cause the cryogenic fluid to be heated to convert it into gas form, and to admit the fluid in gas form from the first pressure tank through a first ejector from among the at least one ejector, such that the fluid in gas form acts as a motive fluid to cause evacuation of the second pressure tank as it passes through the first ejector.

According to a second aspect of the present invention, there is provided a method comprising admitting cryogenic fluid from a storage tank to a first pressure tank and causing the cryogenic fluid to be heated to convert it into gas form in the first pressure tank, admitting the fluid in gas form from the first pressure tank through a first ejector, such that the fluid in gas form acts as a motive fluid to cause evacuation of a second pressure tank as it passes through the first ejector, after the second pressure tank has been evacuated, admitting cryogenic fluid from the storage tank to the second pressure tank and causing the cryogenic fluid to be heated to convert it into gas form in the second pressure tank, and admitting the fluid in gas form from the second pressure tank through either the first ejector or a second ejector, such that the fluid in gas form acts as a motive fluid to cause evacuation of the first pressure tank as it passes through the first or the second ejector.

According to a third aspect of the present invention, there is provided a computer program configured to cause a method according to the second aspect to be performed, when run on a computer.

According to a fourth aspect of the present invention, there is provided a non-transitory computer readable medium having stored thereon a set of computer readable instructions that, when executed by at least one processor, cause an apparatus to at least admit cryogenic fluid from a storage tank to a first pressure tank and cause the cryogenic fluid to be heated to convert it into gas form in the first pressure tank, admit the fluid in gas form from the first pressure tank through a first ejector, such that the fluid in gas form acts as a motive fluid to cause evacuation of a second pressure tank as it passes through the first ejector, after the second pressure tank has been evacuated, admit cryogenic fluid from the storage tank to the second pressure tank and cause the cryogenic fluid to be heated to convert it into gas form in the second pressure tank, and admit the fluid in gas form from the second pressure tank through either the first ejector or a second ejector, such that the fluid in gas form acts as a motive fluid to cause evacuation of the first pressure tank as it passes through the first or the second ejector.

### BRIEF DESCRIPTION OF THE DRAWINGS

FIG. 1 illustrates an example system in accordance with at least some embodiments of the present invention;

FIG. 2 illustrates an example system in accordance with at least some embodiments of the present invention;

FIG. 3 illustrates an example system in accordance with at least some embodiments of the present invention;

FIG. 4 illustrates an example apparatus capable of supporting at least some embodiments of the present invention;

FIG. 5 illustrates internal evaporation chambers in accordance with various embodiments of the present invention, and

FIG. 6 is a flow graph of a method in accordance with at least some embodiments of the present invention.

### EMBODIMENTS

Embodiments disclosed herein relate to cryogenic fluid conveyance without resorting to pumps with moving parts, thereby simplifying handling of cryogenic fluids, such as, for example, liquid hydrogen or liquefied natural gas, LNG. Avoiding moving parts, aside from valves, results in increased reliability, simpler construction and reduced maintenance of the cryogenic fluid handling system. Further, in some embodiments use of external electricity may be avoided in running fluid conveyance, as the fluid conveyance may be driven by ambient heat. Ejectors are employed in embodiments described herein, such that gas-phase fluid being led from a pressure tank through an ejector evacuates another pressure tank of residual gas through the action of the ejector, as an entrained flow.

Embodiments of the present invention may find application, for example, in LNG shipping and LNG-powered marine vessels, or, for example, liquid hydrogen, LH2, powered marine vessels, rail, working machine or LH2/LO2 submarine applications. LH2 is a prospective means for transporting large quantities of energy. Oxidizing hydrogen in fuel cells does not in itself produce any carbon emissions. Storing hydrogen in liquid form enables storing approximately twice the quantity of hydrogen, and in a lighter tank, compared to storing the hydrogen in a high-pressure gas form. Using liquid hydrogen, however, introduces the need to convey it from storage to application, which has conventionally required using low-temperature pumps, gas-phase pumps or gas-phase compressors with buffer tanks. Using an ejector-based fluid conveyance mechanism does away with the need for such pumps. LH2 may be stored maintaining its temperature constant by a continuous, slow evaporation. A storage temperature for LH2 may range from 21 to 33 Kelvin, with a pressure of 1 to 12 bars, for example. The density of LH2 ranges from 70 to 45 kg/m³, while, for example, a density of 700-bar gaseous H2 may be from 41 to 37 kg/m³ (at 5-50° C.). Consequently, the lower storage pressure of LH2 may be preferred to maximize storage capacity. A low storage pressure may also be preferred to minimize mechanical requirements for storage tank(s).

LNG is similar to LH2 in that it is a cryogenic fluid and it may be conveyed using similar technical solutions, such as ejector-based solutions. Compared to LH2, LNG has a higher evaporation temperature and higher density. Storage temperature of LNG varies generally between −163° C. to −140° C. at a storage pressure of ca. 1-10 atmospheres. The density of LNG ranges from 490 kg/m³ to 435 kg/m³.

In general an ejector is a device admitting two flows of fluid, a primary flow and a secondary flow, via a primary inlet and a secondary inlet, respectively. The primary flow may be pressurized and composed of a motive fluid. As the motive fluid flows through the ejector it interacts with gas in the ejector, which begins to follow the motive fluid due to frictional/dynamic interactions with molecules comprised in the motive fluid. The co-movement of the non-motive gas with the motive fluid generates an under-pressure at the secondary inlet, which may be used to suck the secondary flow through the secondary inlet, powered by the dynamic movement force of the primary flow. The motive fluid may comprise gas flowing under pressure, and the secondary flow may in fact be composed chemically of the same gas as the motive fluid.

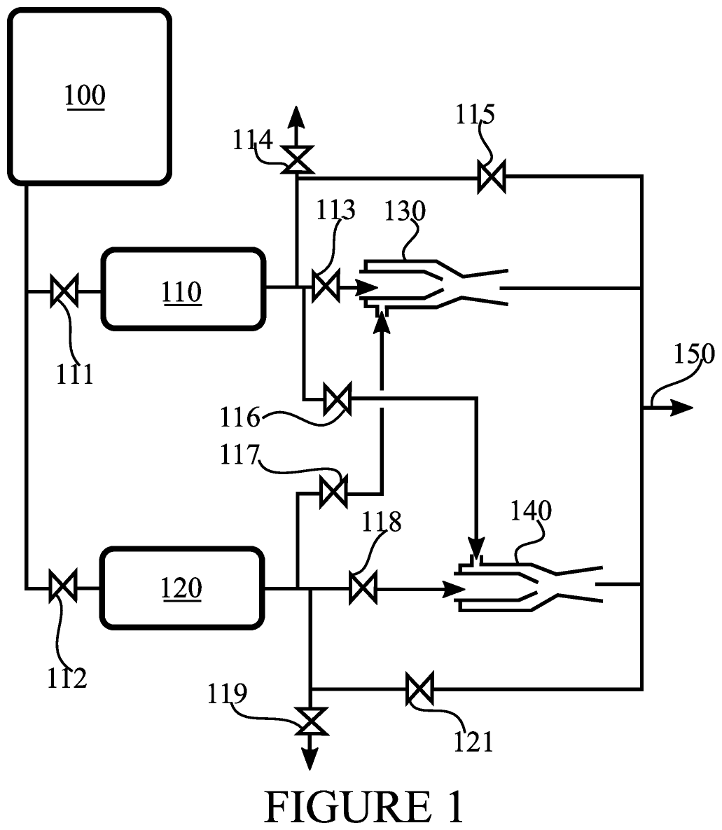

FIG. 1 illustrates an example system in accordance with at least some embodiments of the present invention. A cryogenic liquid storage tank 100 may be composed of steel, for example, and store a quantity of cryogenic fluid which may comprise, for example, LNG, liquid hydrogen or, indeed, another suitable cryogenic liquid. Application 150 may comprise a combustion unit where the fluid is combusted, or another suitable application, such as a fuel cell, of the fluid. Application 150 may be configured to receive the fluid in gas form. Storage tank 100 may be thermally insulated and/or refrigerated to maintain a cryogenic temperature of its contents.

In use, a quantity of cryogenic fluid is admitted from storage tank 100 to pressure tank 110. Pressure tank 110 may comprise an internal evaporation chamber therein, such that when the cryogenic fluid is admitted through valve 111 to pressure tank 110, the fluid settles in the internal evaporation chamber. At the start of the process, pressure tanks 110 and 120 may be in an evacuated state, for example. Alternatively, the pressure tanks may be filled with pressurized gas in their first fillings, as the process is initiated. Pressurized gas may be available from a bottle or a compressor, for example. Valve 111 is closed and the fluid in pressure tank 110 is allowed to warm up, whereby it undergoes a phase transition from liquid to gas phase, significantly increasing a pressure in pressure tank 110. Pressure tanks 110 and 120 may be designed to withstand a pressure of 200 or 700 bars, for example.

In some embodiments, at least one of the pressure tanks is interfaced with a heater to cause the cryogenic fluid to warm up. As the liquid is cryogenic, circulating a liquid at ambient/room temperature would already cause heating of the fluid. A heater may also be used to increase a pressure of gas-phase fluid in a pressure tank, which may make it easier to design a synchronization sequence for the system. Such heating arrangements are described in more detail herein below.

Once the fluid has been converted to gas phase and temperature in the tank is sufficiently elevated, pressure in pressure tank 110 is high. The temperature at the pressure tank surface should not be too low, to avoid stressing the tank due to thermal expansion. Also, in general, to avoid condensing of atmospheric oxygen the system may be designed such that the outer surfaces of components in contact with the cryogenic fluid on the inside, and air on the outside, remain above the boiling temperature of oxygen at all times (ca. −183° C. at 1 atm). Thus the gas may be directed to application 150 through bypass valve 115, or through ejector 130. Valve 116 may be closed. Once the pressure in pressure tank 110 has dropped to the application pressure, the flow of gas will stop, with some residual gas remaining in pressure tank 110. The residual gas would hinder re-filling of pressure tank 110 from storage tank 100 without a pump. Valves 113 and/or 115 may be set to a closed state once the flow of gas from pressure tank 110 to application 150 has stopped, or significantly decreased.

Next, pressure tank 120 is filled from storage tank 100, through valve 112. Valve 112 is then closed and the fluid in pressure tank 120 is caused to transition to the gas phase, as was done with the fluid in pressure tank 110 earlier. Once the fluid is in gas phase and pressure tank 120 thus contains a high gas pressure, valve 118 may be opened, resulting in a flow of gas from pressure tank 120, through ejector 140, to application 150.

The flow of gas from pressure tank 120 to application 150 acts as a primary flow, also known as a motive fluid, in ejector 140. The primary flow causes a secondary flow, or entrained flow, from pressure tank 110 through opened valve 116, which evacuates pressure tank 110 to a lower pressure. This evacuation reduces the amount of residual gas in pressure tank 110, such that the pressure in tank 110 is sufficiently low to enable filling pressure tank 110 with cryogenic fluid from storage tank 110 once again, without using a pump. Once tank 110 is sufficiently full, valve 116 may be used to prevent unevaporated cryogenic liquid flow out from tank 110 although valve 116 may be open simultaneously with valve 118, due to ejector construction.

The process then advances to re-filling pressure tank 110 with cryogenic fluid, taking advantage of the lowered pressure in pressure tank 110. The fluid in pressure tank 110 is then caused to transition to gas phase, increasing pressure in pressure tank 110. Pressure tank 110 may then be emptied through valve 113 and ejector 130, to application 150, such that the flow of gas from pressure tank 110 to application 150 forms the primary flow of ejector 130, and a secondary flow is entrained from pressure tank 120, through opened valve 117, to reduce the amount of residual gas in pressure tank 120 sufficiently to enable re-filing of pressure tank 120 without a pump. The secondary flows do not need to completely evacuate the other pressure tank, in other words no high-grade vacuum is needed, rather, it is sufficient that pressure in the tank is lowered to a level where re-filling the pressure tank with a new batch of cryogenic fluid from storage tank 100 is possible.

Operating thus, the pressure tanks 110, 120 can, in turn, evacuate each other through the ejectors 130, 140 to reduce the pressure in each other to enable re-filling the pressure tanks from storage tank 100 without a separate pump mechanism.

Advantageously, gas need not be vented from the pressure tanks, which saves gas, and no electricity need be used in pumping the gas as the gas is conveyed to application 150 using pressure generated by allowing the fluid to heat up and transition to the gaseous phase. Gas may be admitted to the application via a regulator, for example, which is not illustrated in FIG. 1 for the sake of clarity.

FIG. 1 comprises further optional safety valves 114 and 119, which may be used, when needed, to prevent damage to the system due to pressure shocks, for example. Further, FIG. 1 comprises optional bypass valves 115, 121. These valves may be used to admit gas from pressure tanks 110 and 120, respectively, to application 150 in situations where pressure remaining in the pressure tank is too low to drive an ejector, but remains high enough for application 150. Where the optional bypass valves are absent, the pressure tanks may be relieved of their pressure via the ejectors. The bypass valves admit gas from the pressure tanks to the application directly in the sense that gas passing through the bypass valves 115, 121 toward application 150 does not pass through an ejector 130, 140.

Operating the system illustrated in FIG. 1 may be performed under the direction of a controller, which is not illustrated in FIG. 1. The controller may comprise at least one processing core and memory, with computer readable instructions in the memory configured to direct the functioning of the controller, when executed by the at least one processing core. The controller may synchronize the operation of the valves and possible heater(s), such that the system performs as described herein. The details of such synchronization depend on, for example, characteristics of ejectors which are chosen for a specific implementation. The synchronization sequence may be optimized using, for example, numerical computer simulation.

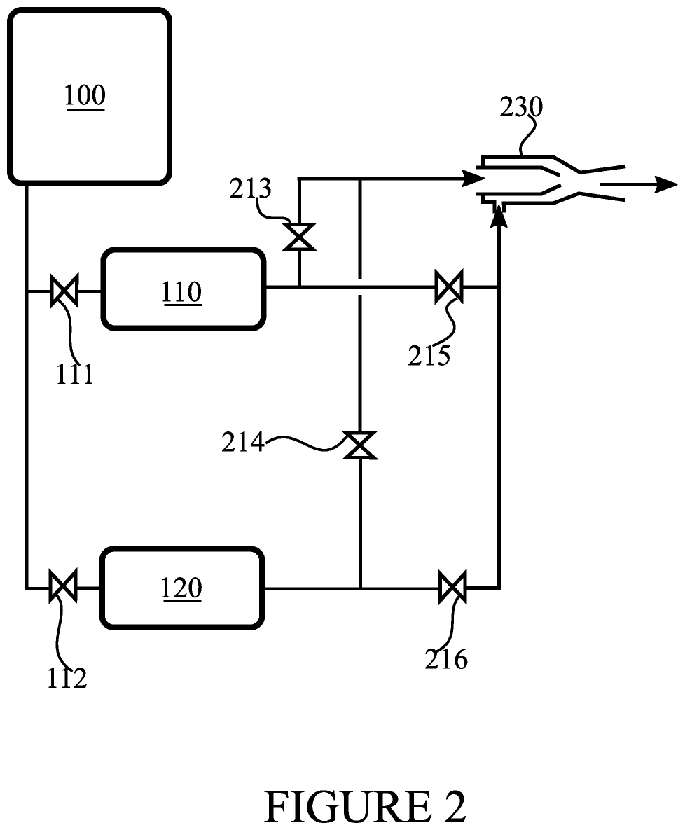

FIG. 2 illustrates an example system in accordance with at least some embodiments of the present invention. The system of FIG. 2 resembles the one in FIG. 1, except in that the system is simplified and only one ejector is needed. Like numbering denotes like structure as in FIG. 1. In FIG. 2, when pressure tank 110 is emptied as the primary flow of ejector 230 via valve 213, valve 216 is open to enable evacuating residual gas from pressure tank 120 as a secondary flow of the ejector. Likewise, when pressure tank 120 is emptied as the primary flow of ejector 230 via valve 214, valve 215 is open to enable evacuating residual gas from pressure tank 110 as a secondary flow of the ejector.

Compared to the system illustrated in FIG. 1, the FIG. 2 system has a narrower parameter space in which it can be operated and the flow of gas may be less smooth, on the other hand, it is simpler and more light-weight, which may be useful in certain vehicular applications, for example. A buffer tank may be usable to compensate for fluctuations in gas flow. Such a buffer tank may be disposed in the application side, for example.

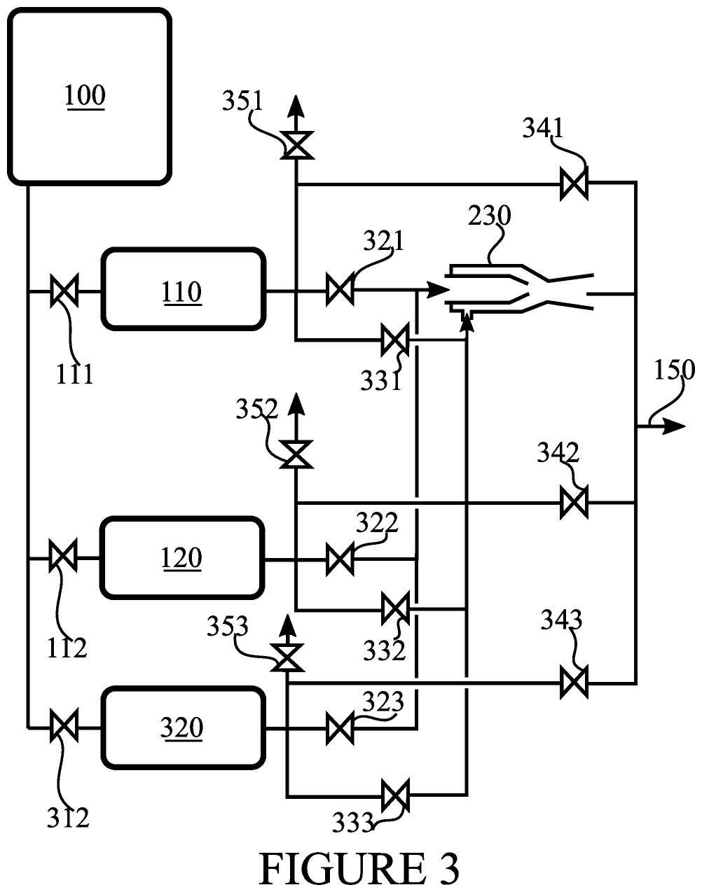

FIG. 3 illustrates an example system in accordance with at least some embodiments of the present invention. Like numbering in FIG. 3 denotes like structure as in FIG. 2. In FIG. 3, a third pressure tank 320 is introduced, which is filled with the cryogenic fluid via valve 312 from storage tank 100.

Each of the pressure tanks 110, 120 and 320 may be in a separate phase of the process at a given time, that is, a first one of the pressure tanks may be being re-filled, a second one of the pressure tanks may be heating the fluid, and a third one of the pressure tanks may be emptying. The evacuation phase, that is, the removal of residual gas from a pressure tank, may take a relatively short period of time. Using three pressure tanks, as in FIG. 3, may enable a relatively smooth output of gas to application 150. Further, an element of redundancy is introduced in to the system, which makes it more fault-tolerant than the FIG. 1 embodiment. Different phases may overlap each other in time, for example such that when one pressure tank is being emptied, another may be filled at the same such that a suction effect generated by an ejector is utilized in the pressure tank to be filled to remove gas which is initially generated from incoming cryogenic fluid owing to warmness of the pressure tank.

Pressure tank 110 uses main valve 321 to provide a primary flow to ejector 230 and secondary valve 331 to provide a secondary flow to ejector 230. Similarly, pressure tank 120 has main valve 322 and secondary valve 332, and pressure tank 320 has main valve 323 and secondary valve 333.

Bypass valves 341, 342 and 343 may be used to provide gas to application 150 without traversing the ejector, for example during the emptying phase when another pressure tank has already been evacuated, using the ejector. Safety valves 351, 352 and 353 may be employed to prevent damage to the system from pressure shocks, for example. The safety valves and bypass valves are optional features in the sense that not all embodiments in accordance with FIG. 3 have them. Some embodiments may comprise the bypass valves but not the safety valves, while some embodiments may comprise the safety valves but not the bypass valves.

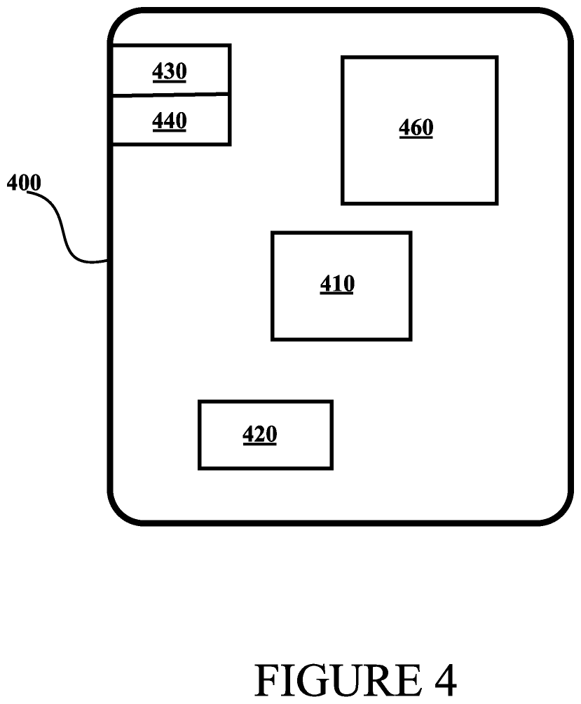

FIG. 4 illustrates an example controller capable of supporting at least some embodiments of the present invention. Illustrated is device 400, which may comprise, for example, a controller configured to control the functioning of a system such as one illustrated in FIG. 1, FIG. 2 or FIG. 3. Comprised in device 400 is processor 410, which may comprise, for example, a single- or multi-core processor wherein a single-core processor comprises one processing core and a multi-core processor comprises more than one processing core. Processor 410 may comprise, in general, a control device. Processor 410 may comprise more than one processor. Processor 410 may be a control device. A processing core may comprise, for example, a Cortex-A8 processing core manufactured by ARM Holdings or a Steamroller processing core produced by Advanced Micro Devices Corporation. Processor 410 may comprise at least one Qualcomm Snapdragon and/or Intel Atom processor. Processor 410 may comprise at least one application-specific integrated circuit, ASIC. Processor 410 may comprise at least one field-programmable gate array, FPGA. Processor 410 may be means for performing method steps in device 400. Processor 410 may be configured, at least in part by computer instructions, to perform actions.

Device 400 may comprise memory 420. Memory 420 may comprise random-access memory and/or permanent memory. Memory 420 may comprise at least one RAM chip. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part comprised in processor 410. Memory 420 may be at least in part external to device 400 but accessible to device 400.

Device 400 may comprise a transmitter 430. Device 400 may comprise a receiver 440. Transmitter 430 and receiver 440 may be configured to transmit and receive, respectively, information in accordance with at least one communication standard.

Device 400 may comprise user interface, UI, 460. UI 460 may comprise at least one of a display, a keyboard, a touchscreen, a vibrator arranged to signal to a user by causing device 400 to vibrate, a speaker and a microphone. A user may be able to operate device 400 via UI 460, for example to configure gas transfer parameters.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. Device 400 may comprise a fingerprint sensor arranged to authenticate, at least in part, a user of device 400. In some embodiments, device 400 lacks at least one device described above.

Processor 410, memory 420, transmitter 430, receiver 440 and/or UI 460 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the embodiment various ways of interconnecting at least two of the aforementioned devices may be selected without departing from the scope of the present invention.

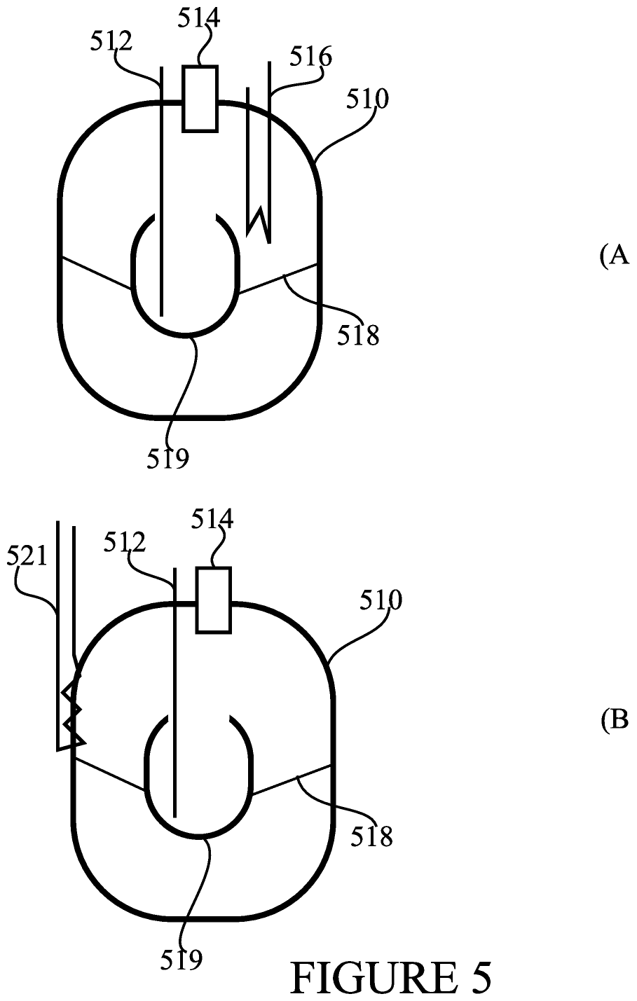

FIG. 5 illustrates internal evaporation chambers in accordance with various embodiments of the present invention. Referring first to the top part of FIG. 5, labelled “(A”, a pressure tank 510 is therein illustrated. Pressure tank 510 may correspond, for example, to any one of pressure tanks 110, 120 and 320 of FIGS. 1, 2 and/or 3, as applicable. Inside pressure tank 510 is disposed an internal evaporation chamber 519, which is suspended in the pressure tank by attachment 518. Attachment 518 may be light-weight and maintain a thermal separation between the walls of pressure tank 510 and internal evaporation chamber 519. Internal evaporation chamber 519 may comprise, for example, a light-weight, thin-shelled metal sphere which is open at the top. Using an internal evaporation chamber provides the advantage that the thermal capacity of the overall heated mass, fluid and chamber, is smaller than otherwise, which increases the size of the parameter space in which the system will work, that is, designing a functioning synchronization scheme for the system is easier and the system will work more reliably.

When using an internal evaporation chamber, the cryogenic fluid may be guided, by lead 512, to a mostly-confined vessel 519, where an initial evaporation of fluid and cooling of mass takes place. After the surface of the internal evaporation vessel 519 reaches the cryogenic liquid temperature, the rest of the filling may take place with very low evaporation of liquid. After the entire batch of cryogenic fluid is in the internal evaporation chamber, heating may commence to transition the fluid to gas phase.

Cryogenic fluid may be introduced from the storage tank into internal evaporation chamber 519 via lead 512. A pressure valve 514 is arranged to admit, under control of the controller, pressurized gas from the pressure tank 510 once the fluid has been caused to transition to the gaseous phase. A heater element 516 is disposed extending into pressure tank 510, to radiatively heat the internal evaporation vessel 519. Heater element 516 may comprise an electric heater, or heater element 516 may comprise a hollow arrangement wherein a heating fluid may flow, to introduce heat into pressure tank 510. In some marine embodiments, the heating fluid may comprise seawater, for example, or a suitable refrigerant or blend of refrigerants, or a low-melting-point heat-transfer fluid such as a mixture of water and ethylene-glycol.

Advantageously, internal evaporation chamber 519 is predominantly comprised of a low-density material with low specific heat capacity, such as, for example, magnesium or aluminium, or of an alloy comprising magnesium and aluminium. This is to provide a condition wherein a heat capacity of the internal evaporation chamber is less than a boiling enthalpy of the cryogenic fluid when it fills the internal evaporation chamber.

Referring then to the lower part of FIG. 5, labelled “(B”, a similar pressure tank 510 is illustrated as in the upper part. Indeed, like numbering denotes like structure in both parts of FIG. 5. A difference between the illustrated tanks lies in the heating arrangement, as the lower tank has a heater element 521, which is coupled to heat pressure tank 510, rather than the internal evaporation chamber 519 more directly. An advantage of heating the pressure tank is that heater element 521 need not penetrate into pressure tank 510, on the other hand, the heating effect is more indirect in this case.

Alternatively to an internal evaporation chamber, a pressure tank may be arranged with an external pressure tank, which is smaller than the pressure tank itself and cryogenically insulated, where the evaporation may take place. Thus also, the pressure tank walls needn't be heated with the cryogenic fluid. Gas could flow from the external pressure tank to the pressure tank.

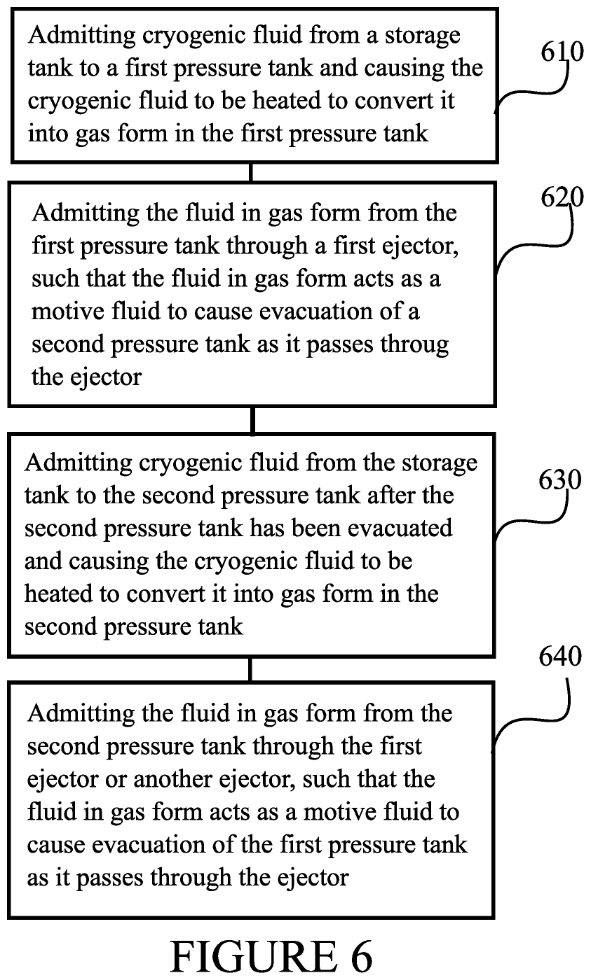

FIG. 6 is a flow graph of a method in accordance with at least some embodiments of the present invention. The phases of the illustrated method may be performed the controller for example.

Phase 610 comprises admitting cryogenic fluid from a storage tank to a first pressure tank and causing the cryogenic fluid to be heated to convert it into gas form in the first pressure tank. Phase 620 comprises admitting the fluid in gas form from the first pressure tank through a first ejector, such that the fluid in gas form acts as a motive fluid to cause evacuation of a second pressure tank as it passes through the first ejector. Phase 630 comprises, after the second pressure tank has been evacuated, admitting cryogenic fluid from the storage tank to the second pressure tank and causing the cryogenic fluid to be heated to convert it into gas form in the first pressure tank. Finally, phase 640 comprises admitting the fluid in gas form from the second pressure tank through either the first ejector or a second ejector, such that the fluid in gas form acts as a motive fluid to cause evacuation of the first pressure tank as it passes through the first or the second ejector.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in handling cryogenic fluids.

### ACRONYMS LIST

LH2 Liquid hydrogen
LNG liquefied natural gas
LO2 Liquid oxygen

REFERENCE SIGNS LIST

| | |
|---|---|
| 100 | Storage tank |
| 110, 120, | Pressure tank |
| 320, 510 | |
| 130, 140, | Ejector |
| 230 | |
| 111, 112, | Inlet valve |
| 312 | |
| 114, 119, | Safety valve |
| 351, 352, | |
| 353 | |
| 115, 121, | Bypass valve |
| 341, 342, | |
| 343 | |
| 113, 118, | Main valve |
| 213, 214, | |
| 321, 322, | |
| 323 | |
| 116, 117, | Secondary valve |
| 215, 216, | |
| 331, 332, | |
| 333 | |
| 400-460 | Structure of the device of FIG. 4 |
| 519 | Internal evaporation chamber |
| 512 | Fluid lead |
| 514 | Pressure valve |
| 516, 521 | Heater element |
| 518 | Attachment |
| 610-640 | Phases of the method of FIG. 6 |

1. A system comprising:
a cryogenic liquid storage tank;
a first pressure tank and a second pressure tank, both connected via leads to the storage tank;
at least one ejector, each of the at least one ejector being connected via leads to both pressure tanks, and
a controller, the controller being configured to admit cryogenic fluid from the storage tank to the first pressure tank, to cause the cryogenic fluid to be heated to convert it into gas form, and to admit the fluid in gas form from the first pressure tank through a first ejector from among the at least one ejector, such that the fluid in gas form acts as a motive fluid to cause evacuation of the second pressure tank as it passes through the first ejector.

2. The system according to claim 1, wherein the system comprises exactly one ejector.

3. The system according to claim 1, wherein the system comprises exactly two pressure tanks and exactly two ejectors.

4. The system according to claim 1, wherein the system comprises exactly three pressure tanks, the first and the second pressure tank being comprised in the exactly three pressure tanks, and wherein the system comprises exactly one ejector.

5. The system according to claim 1, wherein the system further comprises a heater adapted to heat at least one of the pressure tanks, to thereby convert the cryogenic fluid to gas.

6. The system according to claim 1, wherein each pressure tank comprises therein an internal evaporation chamber adapted to receive the cryogenic fluid.

7. The system according to claim 6, wherein the internal evaporation chamber is predominantly comprised of magnesium and/or aluminium.

8. The system according to claim 6, wherein the heater is configured to heat the internal evaporation chamber.

9. The system according to claim 8, wherein the heater is arranged to heat the cryogenic fluid by radiative heating of the internal evaporation chamber.

10. The system according to claim 6, wherein a heat capacity of the internal evaporation chamber is less than a boiling enthalpy of the cryogenic fluid when it fills the internal evaporation chamber.

11. A method comprising:
admitting cryogenic fluid from a storage tank to a first pressure tank and causing the cryogenic fluid to be heated to convert it into gas form in the first pressure tank;
admitting the fluid in gas form from the first pressure tank through a first ejector, such that the fluid in gas form acts as a motive fluid to cause evacuation of a second pressure tank as it passes through the first ejector;
after the second pressure tank has been evacuated, admitting cryogenic fluid from the storage tank to the second pressure tank and causing the cryogenic fluid to be heated to convert it into gas form in the second pressure tank, and
admitting the fluid in gas form from the second pressure tank through either the first ejector or a second ejector, such that the fluid in gas form acts as a motive fluid to cause evacuation of the first pressure tank as it passes through the first or the second ejector.

12. The method according to claim 11, further comprising heating the cryogenic fluid in the first pressure tank.

13. The method according to claim 12, wherein the cryogenic fluid is heated in an internal evaporation chamber comprised in the first pressure tank.

14. The method according to claim 13, wherein the heating comprises radiative heating of the internal evaporation chamber.

15. The method according to claim 13, wherein the internal evaporation chamber is predominantly comprised of magnesium and/or aluminium.

16. The method according to claim 12, wherein the cryogenic fluid is heated in batches.

17. (canceled)

18. A non-transitory computer readable medium having stored thereon a set of computer readable instructions that, when executed by at least one processor, cause an apparatus to at least:
admit cryogenic fluid from a storage tank to a first pressure tank and cause the cryogenic fluid to be heated to convert it into gas form in the first pressure tank;
admit the fluid in gas form from the first pressure tank through a first ejector, such that the fluid in gas form acts as a motive fluid to cause evacuation of a second pressure tank as it passes through the first ejector;
after the second pressure tank has been evacuated, admit cryogenic fluid from the storage tank to the second pressure tank and cause the cryogenic fluid to be heated to convert it into gas form in the second pressure tank, and
admit the fluid in gas form from the second pressure tank through either the first ejector or a second ejector, such that the fluid in gas form acts as a motive fluid to cause evacuation of the first pressure tank as it passes through the first or the second ejector.

19. The non-transitory computer readable medium according to claim 18, wherein the apparatus is further caused to: heat the cryogenic fluid in the first pressure tank.

20. The non-transitory computer readable medium according to claim 19, wherein the cryogenic fluid is heated in an internal evaporation chamber comprised in the first pressure tank.

21. The non-transitory computer readable medium according to claim 20, wherein the heating comprises radiative heating of the internal evaporation chamber.
